(19) United States
(12) Patent Application Publication
(10) Pub. No.: US 2013/0179219 A1
(43) Pub. Date: Jul. 11, 2013

(54) COLLECTION AND MANAGEMENT OF FEEDS FOR PREDICTIVE ANALYTICS PLATFORM

(71) Applicant: Erik Stephen Ross, Charlotte, NC (US)

(72) Inventor: Erik Stephen Ross, Charlotte, NC (US)

(73) Assignee: Bank of America Corporation, Charlotte, NC (US)

(21) Appl. No.: 13/346,508

(22) Filed: Jan. 9, 2012

(51) Int. Cl. G06Q 10/04

(52) U.S. Cl. 705/7.31

(57) ABSTRACT

Embodiments of the invention are directed to a system, method, or computer program product for a predictive analytics platform. First, the platform may be populated by individuals or entities with data. The data may then be categorized into a searchable format. The data may be analyzed to create feed category data and patterns that may provide indications of future trends. The future trends may be in the financial, risk, or product development fields. In this way, the invention may combine data from multiple sources into a single platform for predictive analytics, thus using current data to attempt to predict future trends. Individuals and entities may have access to the platform to analyze the data on the platform or receive patterns previously provided by the system, in order to further predict future trends.

### BACKGROUND

Currently, entities utilize feedback groups, focus groups, engineers, historical trends, current product availability, and the like to predict future trends and to develop new products. For example, historical trends in the weather provide predictions for future tornado seasons, winter storms, and the like. In another example, if a toy company is planning to manufacture a new toy, the company may use a focus group to provide feedback and satisfaction ratings for the toy prior to it being sold.

Utilizing various prediction models aid in providing cost effective research development and marketing for entities. In this way, entities may pinpoint specific products or markets and eliminate the cost of developing other products and markets.

Entities are constantly searching for predictors of future trends. Although, utilizing feedback groups, focus groups, or other consumer driving groups may provide cumbersome to the entity, it is worthwhile to attempt to predict future consumer purchases, the weather, stock trends, financial trends, or the like for the betterment of the entity.

Predicting future trends may require entities to search through a large amount of data in order to attempt to predict future trends.

Therefore, a need exists for a comprehensive collection and management of potential future trend determinants.

### BRIEF SUMMARY

Embodiments of the present invention address the above needs and/or achieve other advantages by providing apparatuses (e.g., a system, computer program product and/or other devices) and methods for a financial institution provided predictive analytics platform that analyzes data feeds, determines patterns from the data feeds predicting future trends, and providing such data feeds and/or patter to third parties for analysis. The predictive analytics platform may be populated by individual or entity feed providers. In some embodiments, the system may receive feeds automatically from an individual or entity. In other embodiments, the system may receive feeds that are manually inputted by an individual or entity and submitted to populate the platform. Once the feeds are provided, the system may manage the feeds that are being received in real-time. Management of the feeds includes providing security functionality, monitoring functionality, and categorizing the feeds on the platform. The security functionality provides the predictive analytics platform with a means of protecting the feed data which is populating the platform, such that viruses, spyware, and the like may not populate the platform and cause problems for the system. Furthermore, the security functionality provides the predictive analytics platform with a means of allowing only secure access, through secure authentication of both feed providers and requestors accessing the predictive analytics platform. The monitoring functionality allows the system to monitor the activity on the platform. In this way, the data and patterns that the requestor searches may be monitored, such that popular feeds and patterns may be realized and fees may be determined based on the requestor's use of the platform. The categorizing of feeds provides for easy requestor searching based on either the category of feed or the field of future trend the requestor is searching for, such as, but not limited to financial, risk, and/or product development.

Once the feeds are categorized, the system may analyze the feeds to determine patterns based on the feed data, the patterns may be predictive of potential future trends. In this way, the system may compile the feeds and analyze them in order to provide patterns of data that may aid a requestor in determining future trends in various fields.

The system may then allow a requestor to access the platform to search for feed data and/or patterns that may aid in predicting future trends for a field the requestor desires. In some embodiment, the system may allow any requestor access the predictive analytics platform. In other embodiments, the system may only allow access to the predictive analytics platform to authorized requestors. Once the system has allowed a requestor to access to the predictive analytics platform, the system may allow the requestor to search the platform for feed data based on category or based on predictive analytic trends the requestor may be looking for. The system provides searching capabilities via keyword, field, category, date, etc. such that the requestor may easily search and find data on the predictive analytics platform.

In some embodiments, the system may use the monitoring functionality of the predictive analytics platform to determine the fees associated with the requestor accessing the data on the predictive analytics platform. Fees may be determined based on a flat fee, the requestor's use of the platform, the amount of data the requestor accesses, etc. Furthermore, feed providers may be compensated for the feeds that they have provided to the platform.

Embodiments of the invention relate to systems, methods, and computer program products for storing in a storage device data feeds provided by feed providers, wherein the data feeds are received in real-time; managing the data feeds by storing the data feeds based at least in part on a category associated with each data feed; predicting patterns from the data feeds using predictive analytics, wherein the patterns indicate future trends in a field; receiving one or more requests from one or more requestors to access either one or both a data feed or a pattern associated with a data feed; determining which data feeds or patterns that are requested more frequently; and determining at least one additional pattern indicating future trends for one or more of the more frequently requested data feeds or patterns associated with a data feed.

In some embodiments, the invention further comprises receiving a fee from a requestor for the use of the predictive analytics platform, wherein the fee is based at least in part on the feed data and/or patterns the requestor accesses. The patterns indicate future trends in one or more of financial, risk, or product development fields.

In some embodiments, the invention further comprises receiving feed data from the feed provider automatically, wherein the feed data is received in real-time upon the submission of feed data to a third party. The feeds provided by the feed provider relate to one or more of financial, risk, or product development fields. The third party, in some embodiments, hosts a mobile device, wherein upon submission of data to the mobile device, the data is received in real-time as feed data at the predictive analytics platform. The third party, in other embodiments may hosts a website, wherein upon submission of data to a website, the data is received in real-time as feed data at the predictive analytics platform. The third party, in still other embodiments may be a financial institution, wherein upon submission of data during a transaction, the data is received in real-time as feed data at the predictive analytics platform.

In some embodiments, the invention further comprises determining a compensation amount to provide to the feed provider based at least in part on the amount of data provided by the feed provider. In still other embodiments, the invention comprises adjusting the category associated with each data feed to include more categories relating to more frequently requested data feeds.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, which are not necessarily drawn to scale, wherein:

FIG. 1 provides a high level process flow illustrating a financial institution provided predictive analytics platform process for providing feeds and accessing the platform, in accordance with one embodiment of the present invention;

FIG. 2 provides a predictive analytics system and environment for collecting feeds and providing access to the platform, in accordance with one embodiment of the present invention;

FIG. 3 provides a predictive analytics feed process flow including feed category data, in accordance with one embodiment of the present invention;

FIG. 4 provides a feed receiving process flow, in accordance with one embodiment of the present invention; and

FIG. 5 provides a feed distribution process flow, in accordance with one embodiment of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to elements throughout. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Although some embodiments of the invention herein are generally described as involving a “financial institution,” one of ordinary skill in the art will appreciate that other embodiments of the invention may involve other businesses that take the place of or work in conjunction with the financial institution to perform one or more of the processes or steps described herein as being performed by a financial institution.

This disclosure is written in terms of a financial institution providing the predictive analytics platform. It is understood that the invention is meant to provide some form of predictive analytics platform for use by entities to determine future trends. The provider of the predictive analytic platform should not be limited to a financial institution, but instead include any institution that may be in a position to provide data to implement with respect to providing future trends.

Throughout the disclosure the terms provider and requestor are used. These terms should not be limited to an individual, but instead include any person, business, manufacturer, merchant, user, entity, or other institution wishing to either provide feeds to the platform or receive data from the platform.

Throughout the disclosure specific provider or requestor action is described. Specific provider or requester actions may be requests for data on the platform via inputs, searches, or the like and actions may be providing feeds to the platform via inputs, opt-ins, automatically, manually provided data, or the like. In this way, the provider or requestor actions described in further detail below may be automated.

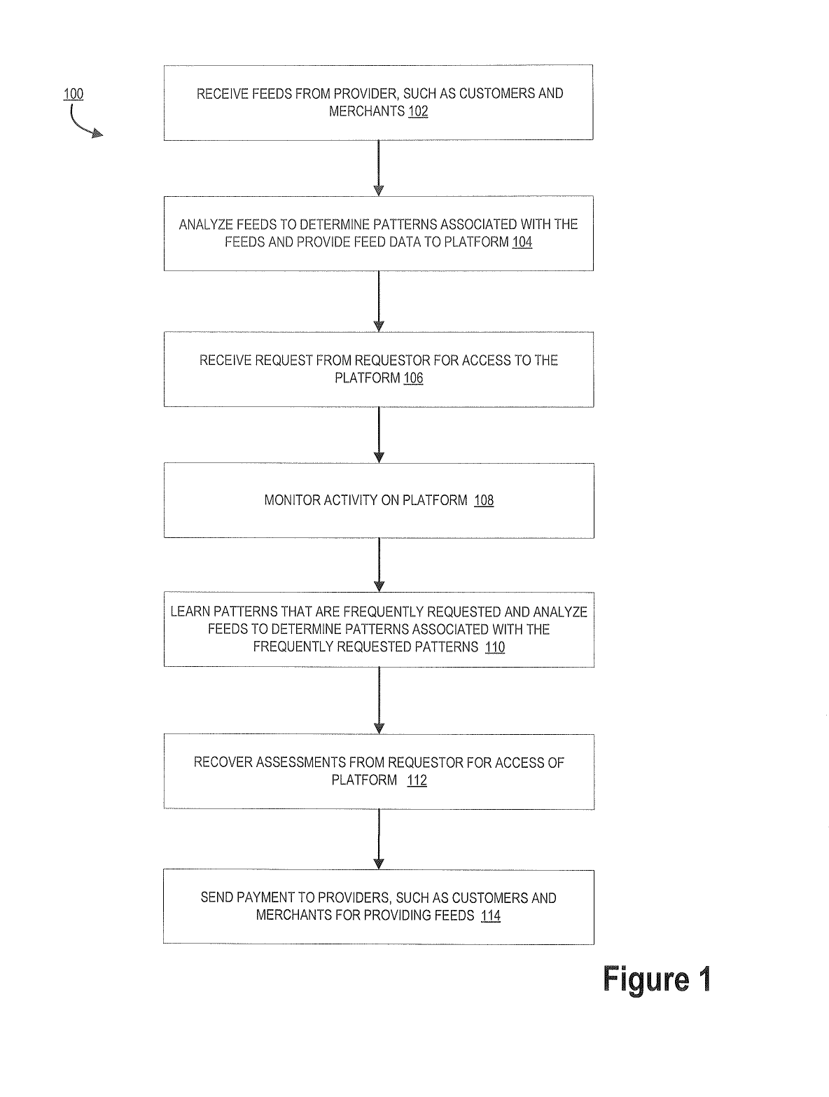

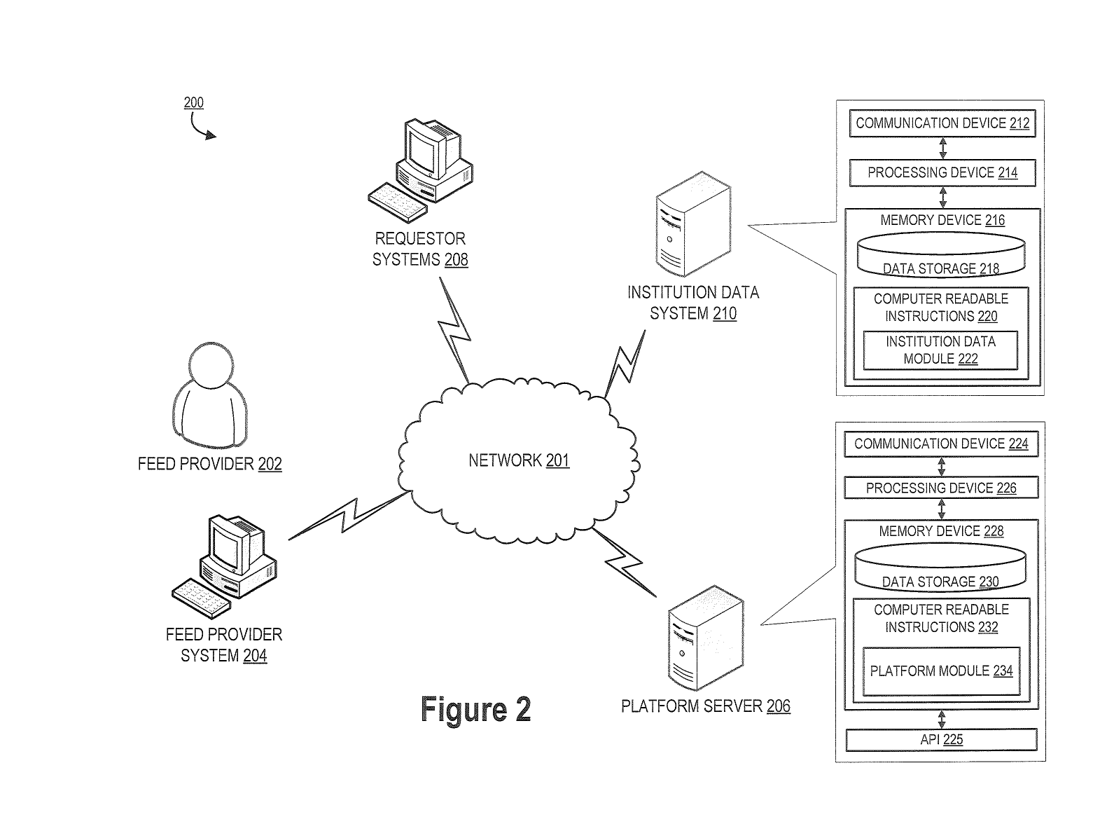

FIG. 1 illustrates a high level process flow for a financial institution provided predictive analytics platform process 100, which will be discussed in further detail throughout this specification with respect to FIGS. 2 through 5. As illustrated in block 102 the predictive analytics platform process 100 includes receiving feeds from a provider. The provider may include, but is not limited to individuals, businesses, manufacturers, merchants, users, entities, or other institutions wishing to provide feeds to the platform. As illustrated in block 104 the predictive analytics platform process 100 may analyze feeds received by a provider to determine patterns associated with the feeds, the feed data and associated patterns may be provided to the platform.

The predictive analytics platform process 100 may then receive a request from a requestor to access the platform as illustrated in block 106. The platform may include patterns in feeds that may provide a requestor with predictive analytics based on the specific use required by the requestor. For example, the requestor may be a toy manufacturer looking to introduce a new toy. Instead of having focus groups, etc. to determine the potential popularity of the new toy, the manufacturer may examine patterns in feeds provided to the predictive analytics platform to determine the potential popularity of the new toy. In this way, the platform may provide patterns specific to the requestor's needs. The patterns and predictive analysis for predicting future trends may be limited to the data collected from the feed providers. The data collected by the feed providers, in some embodiments, allows for prediction of future trends in the financial, risk, and product development fields.

If the requestor is allowed access to the platform, the requestor's activity on the platform, may be monitored, as illustrated in block 108. In block 110, the predictive analytics platform system may be able to learn patterns that requestors most frequently access the platform for and subsequently provide further analysis of the feeds as directed to those frequently requested patterns. Using the monitoring from block 108, the host of the predictive analytics platform may then, as illustrated in block 112, recover fees from requestors for their access of the platform. Fees may be determined in many ways, including, but not limited to being determined by the monitoring of use of the platform such that the more use allows for larger fees, by the amount of access to the platform, by the amount of data requested, by a royalty based on application sales, by a flat fee, a subscription fee, etc. Finally, as illustrated in block 114, the predictive analytics platform process 100 may provide payment to the providers of feeds for the feeds that they sent to the platform.

FIG. 2 provides a predictive analytics system and environment 200 for collecting feeds and providing access to the platform in accordance with one embodiment of the present invention. It is understood that the servers, systems and devices described herein illustrate one embodiment of the invention. It is further understood that one or more of the servers, systems, and devices can be combined in other embodiments and still function in the same or similar way as the embodiments described herein.

The network 201 may be a global area network (GAN), such as the Internet, a wide area network (WAN), a local area network (LAN), or any other type of network or combination of networks. The network 201 may provide for wireline, wireless, mobile, or a combination of wireline, wireless, and mobile communication between devices on the network.

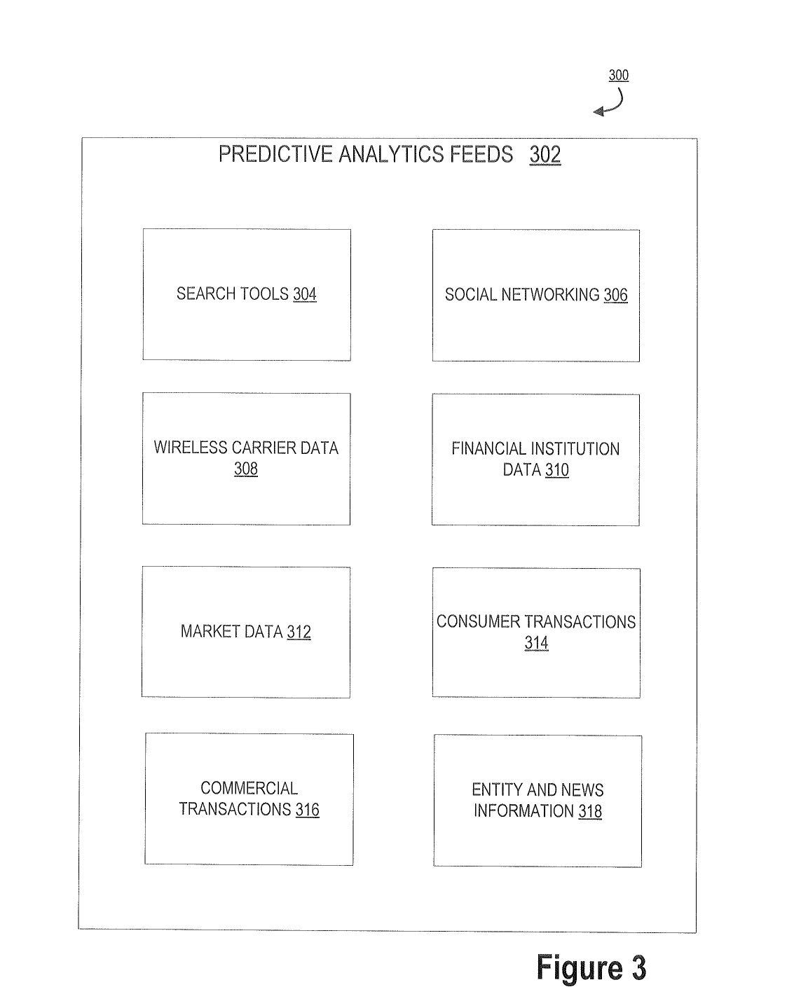

The feed provider 202 may be an individual or entity wishing to provide data to the predictive analytics platform. The feed provider 202 may include, but is not limited to individuals, businesses, manufacturers, merchants, users, entities, website hosts, social networks, data servers, or other institutions wishing to provide data in the form of feeds to the predictive analytics platform. In some embodiments, the feeds may include data that may be utilized by the predictive analytics system 200 to analyze to determine potential future trends. These feeds may be grouped into feed categories described in more detail below with respect for FIG. 3.

In some embodiments, the feed provider 202 has an account associated with the institution providing the predictive analytics platform. For example, the feed provider 202 may have financial accounts with the financial institution providing the predictive analytics platform. The feed provider 202 may allow the predictive analytics platform to have access to his/her financial data associated with the financial accounts, in order to provide this data as feed data. In this example, the financial institution may have transaction data, a feed category, about the feed provider 202 and thus the feed provider 202 may allow for his/her anonymous transaction data to be provided to the predictive analytics platform. In this way, the financial institution may be able to provide data regarding the feed provider 202 to the predictive analytics platform and in return the feed provider 202 may receive payment for his/her data. In some embodiments, the accounts associated with the institution providing the predictive analytics platform may include other accounts, not just financial, that may provide feed data to the predictive analytics platform. For example, health insurance records, other insurance data, medical records, and/or the like may be included as feed data based on accounts associated with institutions associated with the predictive analytics platform.

In other embodiments, the feed provider 202 may be a social network. In this way, the social network may provide feed data about the individuals with accounts on the social networking site. The data may be provided to the predictive analytics system 200 in the form of anonymous data, such as an indication that several social network account holders are purchasing products from Merchant 1 because of a specific feature that the product has that the competing products do not. In this way, the data that is sent from the feed provider 202 is already in the form of a pattern. In other embodiments, the data sent from a feed provider 202 may be raw data that the institution data system 210 may need to analyze.

As illustrated in FIG. 2, the platform server 206 is operatively coupled, via a network 201 to the institution data systems 210, requestor systems 208, and the feed provider system 204. In this way, the platform server 206 can send and receive information to and from the institution data system 210, the requestor systems 208, and the feed provider system 204, to facilitate data share for predicting future trends via the predictive analytics platform. FIG. 2 illustrates only one example of an embodiment of a predictive analytics system and environment 200, and it will be appreciated that in other embodiments one or more of the systems, devices, or servers may be combined into a single system, device, or server, or be made up of multiple systems, devices, or servers.

The platform server 206 generally comprises a communication device 224, a processing device 226, a memory device 228, and an API 225. As used herein, a “processing device” generally refers to a device or combination of devices having circuitry used for implementing the communication and/or logic functions of a particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device may include functionality to operate one or more software programs based on computer-readable instructions thereof, which may be stored in a memory device.

The processing device 226 is operatively coupled to the communication device 224 and the memory device 228. The processing device 226 uses the communication device 224 to communicate with the network 201 and other devices on the network 201, such as, but not limited to the institution data system 210, the feed provider system 204, and requestor systems 208. As such, the communication device 224 generally comprises a modem, server, or other device for communicating with other devices on the network 201.

The API 225 provides the ability to transmit and/or receive data or other messages associated with the predictive analytics platform server 206. In some embodiments, APIs may be provided in the systems or servers of the predictive analytics platform system 200, such as, but not limited to the feed provider system 204, the requestor system 208, the institution data system 210, the platform server 206, and/or the like. In some embodiments, such as described in FIG. 2, an API 225 communicates with the systems of the predictive analytics platform system 200. In this way, the software of each system may be implemented to communicate to transmit and/or receive data or messages. In one example, the API 225 may be executed by the processing device 226 such that the API 225 may interface with any resident programs such as the platform module 234. In another example, the processing device 226 may instruct the communication device 224 to interact with an API of a specific system of the predictive analytics platform system 200.

As illustrated in FIG. 2, the platform server 206 comprises computer-readable instructions 232 stored in the memory device 228, which in one embodiment includes computer-readable instructions 232 for a platform module 234. In some embodiments, the memory device 228 includes data storage 230 for storing data related to the platform server 206, but not limited to the data created and/or used by the platform module 234.

In the embodiment illustrated in FIG. 2, and described throughout much of this specification, the platform module 234 allows for posting of patterns, posting of analyzed feed category data, access to the data and patterns on the platform server 206 for a requestor, search capabilities, security of the platform server 206, monitoring of the platform server 206, fee analysis, pattern recognition, visualization of data, and pattern learning on the platform server 206. The platform server 206 is the server associated with the predictive analytics platform or platform, as used herein.

In some embodiments the platform module 234 allows for the posting of analyzed feed category data and patterns established from that feed data to the predictive analytics platform. Retrieving feeds, analyzing the feeds, and establishing patterns based off of the feeds are all performed, in some embodiments, by the institution data system 210 and will be described in more detail below with respect to the institution data system 210.

The feed category data may be received from a feed provider 202 at the institution data system 210. Once the institution data system 210 has analyzed the data, the analyzed feed category data may be provided to the platform server 206. The platform module 234 allows for requestors to access the analyzed feed category data. The data may be in several different categories, including, but not limited to search tools, social networking, wireless carrier data, financial institution data, market data, health and medical records, consumer transactions, commercial transactions, and entity and news information. In this way, the requestor may be able to search by category or search by group of category in order to find data that may allow the requestor to predict potential future trends in a field of interest to the requestor. Therefore, the platform module 234 may provide the requestor with a variety of search capabilities.

The pattern data may be determined by the institution data system 210. Once the institution data system 210 has analyzed the feed category data, the analyzed feed category data may allow the institution data system 210 to determine patterns in data that may provide reliable for predicting future trends. Patterns, in some embodiments, may relate to the financial and risk fields, such as predicting stock market trends. Patterns may also relate to the product development field. In other embodiments, the patterns may relate to fields that the requestor requests. In this way, the feed category data may be analyzed to determine predictive future trends in any field that the requestor requests.

Once patterns are determined, the institution data system 210 may provide the pattern data to the platform server 206. The platform module 234 allows for requestors to access the patterns on the platform server 206. As described above, the patterns may relate to financial, risk, and/or product development fields. For example, the patterns developed from the categorized feed data may indicate that home purchases may be on the rise based on financial patterns and the like. In other embodiments, the patterns may relate to fields that the requestor may request future trends be analyzed. The patterns may be limited based on the feed category data from search tools (search engine results, computer use of user, etc.), social networking, wireless carrier data (mobile device data, GPS data, geo-spatial data, etc.), financial institution data (account data, loan data, insurance data, etc.), market data, consumer transactions (including point-of-transaction data, purchase data, account data, product purchase data, etc.), commercial transactions (including point-of-transaction data, orders, inventories, shipments, in-transit stock, company data, sales, annual reports, security camera data, etc.), and entity and news information (news press releases, conferences, mobile data, live television, traffic, etc.). In this way, the patterns may potentially be limited to the feed category data from which the patterns are based. The platform module 234 may allow a requestor to search patterns related to fields, such as financial, risk, and/or product development. The platform module 234 may further allow a requestor to place a request with the platform module 234 to receive patterns for other fields that the requestor may wish to attempt to predict future trends. Therefore, the platform module 234 may provide the requestor with a variety of search capabilities with respect to patterns.

In some embodiments, the platform module 234 allows a requestor to access the platform server 206 to retrieve feed category data and patterns. In some embodiments, the feed category data and patterns may be stored in the memory device 228 of the platform server 206. The platform module 234 allows for the requestor to communicate, via the requestor system 208, to request and receive feed category data and patterns from the platform module 234. The request may be received directly from a requestor system 208, through the use of an API, the requestor may request the data via an interface, or other means of providing a request, such as a text message, voice message, and/or the like.

In other embodiments, the feed category data and patterns are stored in the memory device 216 of the institution data system 210. In this case, the feed category data and patterns may be received at the platform server 206 through communications with the institution data system 210, and specifically the institution data module 222. In this way, the feed category data and patterns may be received by the requestor, from the platform module 234 after the platform module 234 has received the stored data from the institution data system 210. The feed category data or patterns, again, may be received and implemented at the requestor system 206 by an API 225 at the platform server 206 or an API at the requestor system 206. The feed category data may also be received at the requestor system 206 via an interface, text message, voice message, video message, and/or the like.

Once the platform module 234 has allowed the requestor to access to the predictive analytics platform via the platform server 206 providing the platform. The platform module 234 provides the requestor with functional search capabilities. In this way, the platform module 234 allows the requestor to search for any data that he/she is wishing to access on the predictive analytics platform. In some embodiments, the platform module 234 may allow the requestor to search all feed data and patterns on the platform. In some embodiments, the platform module 234 may allow the requestor to search all of the categories of feed data. In other embodiments, the requestor may be able to search all of the feed category data within a specific feed category. In yet other embodiments, the platform module 234 may allow the requestor to search all patterns available from the platform. Furthermore, the platform module 234 allows a requestor the ability to request for patterns based on feed data that the predictive analytics system 200 has acquired. The platform module 234 may provide powerful search capabilities to the requestor, such as search options including but not limited to keyword searches, category searches, Boolean searches, natural language searches, and the like.

In some embodiments, the platform module 234 provides security functionality for the platform server 206 and the data stored thereon. In other embodiments, the platform module 234 provides security functionality to the feed providers 202 and requestors accessing the platform. In some embodiments, the security functionality may scan the data being provided by the feed provider 202. In this way, irrespective the source of the data from the feed provider 202, the data, once at the institution data system 210 will be secure and free of spyware, viruses, and the like that may interfere with the platform or requestor. Once the data is securely received at the institution data system 210, in some embodiments, prior to allowing the requestor access predictive analytics platform other security functions may be implemented, such as authentication of the requestor access, via security authentication including, but not limited to biometric authentication, password, voice command, and/or the like. The security functions provide the predictive analytic system 200 with protection from security breaches, protection of restricted data being exposed, protection of the amount of data exposed, etc. For example, a requestor may request data from the platform server 206. The security function may determine the data that the requestor is allowed access to the data. This data will be transmitted to the requestor. The remaining data on the platform may be protected from the requestor, based on the security functionality determining that that particular requestor may not be authorized for the other data. In this way, the data on the platform may not be giving to a requestor that may utilize the data for a purpose other than that intended by the predictive analytics system 200. The security function may be also be implemented by the institution data module 222, which may communicate, via a communication device 212, through a network 201 to the platform server 206 to indicate to the platform module 234 potential security issues.

The platform module 234 may also monitor the predictive analytics platform, including, but not limited to the data on the platform and the entities accessing the platform. The platform module 234 may monitor the data received from the institution data system 210 to be put on the platform and the data currently on the platform. In this way, the data stored in the memory device 228 or the platform server 206 may be monitored to determine, for example, the number of feed providers 202 represented in the data, the number of requestors requesting specific data, the number of requestors receiving the data, the use of the data, and the data that is being accessed the most frequently. This data may include feed category data as well as patterns. In this way the platform server 206 thought the platform module 234, may communicate with the institution data module 222 to provided indications as to the activity on the platform based on the specific data monitored. In this way, the institution data system 210 may be able to adjust the feed category data to include more data sets or patterns relating to the more frequently requested feed category data and patterns.

In some embodiments, the platform module 234 may further allow for monitoring of the requestor, the requestor's use of the platform and the data obtained there from. The platform module 234 may monitor the use of the data, the access requests for data, and the data once it is provided to a requestor. The platform module 234 may communicate with the institution data module 222 to monitor data activity within the institution, such as but not limited to the data being viewed by a requestor or the data being provided to the platform. Monitoring may allow the platform server 206 to provide an added security function, an ability to analyze the platform, and an ability to base fees off of use.

In some embodiments, the monitoring capabilities of the platform module 234 may also include security and authentication capabilities of the requestors wishing to gain access to the platform.

The security and authentication capabilities allow the platform module 234 to limit or restrict requestors from accessing data that may not be authorized to do so. The platform module 234 may further provide security by the monitoring of the requestors activity on the platform. This may provide an added security function to ensure no misuse or misappropriation of the data or patterns on the platform. For example, the monitoring function of the platform module 234 may determine that a requestor's use of specific data on the platform may not have been appropriate, and thus, the platform module 234 may provide a security feature to limit that requestor's access to data on the platform in the future.

Furthermore, in some embodiments, monitoring the platform allows the platform module 234 the ability to analyze the platform and the use of the data thereof For example, a requestor's activity on the platform may be monitored such that the data the requestor accesses or navigates through may be gathered by the platform module 234. In this way, the platform module 234 may identify and learn of data and/or patterns that are used or requested by a requestor most frequently.

The platform module 234 monitoring functionality may further allow for a fee analysis function. The fee analysis function may determine fees, if any, a requestor owes for accessing the platform or using the data on the platform. In this way, fees may be based off on the number of accesses to the platform, the amount of data requested from the platform, a flat fee, a subscription fee, and/or a royalty based on use of the data on the platform. For example, a requestor may only wish to access the platform one time, in this case the fee would be charged for that one access. If a requestor wished to access the platform a number of times, each time the requestor accessed the platform a fee would be charged. A fee may be charged based on the amount of data the requestor requests from the platform. This fee may also be dependent on the type of data requested. For example, if a requestor requests several types of feed category data, several patterns, or several individualized pattern requests the fee may be higher than the fee for a requestor requesting a single set of feed category data or a frequently requested pattern. A fee may also be charged based on the use of the data on the platform which may be implemented by means codes embedded in the data. In this way, the predictive analytics system 200 may monitor the feed category data, or patterns once the data has been requested from the platform. The coded data may monitor where the requestor may send the data and provide a royalty to the platform based on the location of the data.

The platform module 234 and the institution data module 222, as described in further detail below, may both provide for pattern recognition and pattern learning. In some embodiments, the platform module 234 may provide for pattern recognition. There are several types of pattern recognition that the platform module 234 may provide the predictive analytics system 200. Patterns include compilations of feed category data within a particular field such as financial, risk, or product development fields. These patterns may attempt to predict future trends. For example, the patterns may include data regarding potential trends in an entity's stock. The patterns may be determined by data related to the entity, entity competitors, secondary considerations, historic data, and the like. In another example, patterns may be used by a financial institution to determine risks associated with loans. In this way, the patterns may determine the risks associated with providing an entity or individual with a loan. These patterns may include financial history, responsibility considerations, family history, payment history, secondary considerations, and the like of the entity or individual. In some embodiments, pattern recognition may include recognizing the feed category data most requested and, in turn, determine the patterns therefrom. In this way, due to the monitoring of the platform, the platform module 234 may be able to determine the feed category data that requestors frequently request. Once that is determined the platform module 234, the platform module 234 may communicate with the institution data system 210 via the institution data module 222 such that the institution data module 222 may analyze the feed data that is most requested and determine subsequent patterns that may be offered to a requestor.

In some embodiments, the platform module 234 provides for pattern learning. In communication with the institution data module 222, the platform module 234 may have an artificial intelligence aspect that allows the platform module 234 to learn and predict patterns that may be used by requestors. In this way, the platform module 234 may learn, using artificial intelligence, potential patterns that may be requested by a requestor. Using the platform module 234 monitoring capabilities the platform module 234 may determine the most requested data from the predictive analytics platform, requestor history, feed provider history, etc. From this data, the platform module 234 may then learn and predict the patterns that may be developed based on the most requested data.

In some embodiments, the platform module 234 may provide for pattern learning based on the feed category data that the platform module 234 may receive from the institution data system 210. In this way, the platform module 234 may receive the feed category data from the institution data system 210 and determine patterns that may predict future trends in the financial, risk, and product development fields. Therefore, the platform module 234 may add patterns to the predictive analytics platform that the platform module 234 may determine based on the feed category data received from the institution data system 210. In this way, the platform module 234 may learn of patterns for predicting future trends utilizing artificial intelligence and learning of potential future trends based on data received by the platform module 234.

As illustrated in FIG. 2, the institution data system 210 is generally comprised of a communication device 212, a processing device 214, and a memory device 216. The processing device 214 is operatively coupled to the communication device 212 and the memory device 216. The processing device 214 uses the communication device 212 to communicate with the network 201 and other devices on the network 201, such as, but not limited to the platform server 206, the feed provider system 204, and the requestor systems 208. As such, the communication device 212 generally comprises a modem, server, or other device for communicating with other devices on the network 201.

As illustrated in FIG. 2, the institution data system 210 comprises computer-readable instructions 220 stored in the memory device 216, which in one embodiment includes computer-readable instructions 220 for an institution data module 222. In some embodiments, the memory device 216 includes data storage 218 for storing data related to the predictive analytics platform including, but not limited data received from a feed provider, patterns, data relating to the institution, and the data created and/or used by the institution data module 222.

In the embodiment illustrated in FIG. 2, the institution data module 222 allows for data to be received in the form of feeds for the predictive analytics platform, categorize the feeds received, analyze the feeds, find patterns associated with the feeds, and learn patterns. The institution data module 222 receives data that may be implemented on the platform. The data may be received from feed providers 202 which may include, but is not limited to individuals, entities, merchants, manufacturers, requestors, the institution itself, etc. and organized on the predictive analytics platform. In one embodiment, the institution data module 222 may receive data from a feed provider 202, such as an individual. For example, an individual may wish to provide feed data to the predictive analytics platform. The data from an individual may include, but is not limited to, social network data, internet search history, transaction or purchase history, financial history, wireless carrier data, and/or the like. In this way, the individual may allow the institution data module 222 to gain access to any or all of the feed data. In some embodiments, the individual may provide the feed data to the institution data module 222. In some embodiments, the individual may allow the institution data module 222 access to the feed information, such that the institution data module 222 may access the feed data from the entity storing the feed data. For example, if an individual allows the institution data module 222 to receive feed data from the individual's social networking sites, the institution data module 222 may access the social networking site and get the feed data directly therefrom. In this way, the individual may not have to provide the feed data to the institution data module 222, but instead the feed data may be automatically provided to the institution data module 222.

In other embodiments, an entity may provide feed data to the predictive analytics platform. The entity may provide feed data to the predictive analytics platform based on an individual's request, as discussed above, or the entity may provide its own data as feed data to the predictive analytics platform. In this way, the entity may provide data to the predictive analytics platform based on another feed provider's 202 request or the entity may be the feed provider 202. If the entity is the feed provider 202, the entity may provide data directly to the institution data system 210. In some embodiments, the data provided from the entity may be its own propriety data, such as product development information, financial data, stock information, etc. In other embodiments, the data provided from the entity may be data that the entity receives from various customers of that entity. For example, a social networking cite or a wireless telephone provider may provide feed data to the predictive analytics platform that the entity received from customers of the entities products. The feed data may be provided in an anonymous form, such that individual identification may not be determined from the data. However, individual social network updates, text message data, and the like may be provided with redacted personal information regarding the individual associated with the same.

In this way, the institution data module 222 may receive data from feed providers 202 which may include, but is not limited to individuals, entities, merchants, manufacturers, requestors, the institution itself, etc. through systems, such as but not limited to the feed provider system 204 or the requestor systems 208, via a network 201. The data, before being communicated to the institution data module 222 may be encrypted such that the data is secure during the communication process, this encryption may include biometric signature encryption. Once the institution data module 222 receives the data, the institution data module 222 may store the data in the memory device 216 and/or provide the data to the platform server 206.

The feed data provided by a feed provider 202 may be uploaded to the institution data module 222, retrieved by the institution data module 222, manually provided to the institution data module 222 through feed provider 202 manual input, such as by an interface, through uploading from a social networking site, etc., automatically provided to the institution data module 222, and/or the like.

Along with receiving the data, the institution data module 222 may further include security (including authentication capabilities) functionality upon the receipt of data. In this way, the feed data received at the institution data module 222 may be screened to prevent corrupt data, viruses, or the like on the predictive analytics platform. The security functionality may be provided in a similar manner as described above respect to the platform module 234. The institution data module 222 may provide security screening the feed data that is received, by limiting the feed providers 202 based on an authorization, and the like. Because the security functionality of the institution data module 222 may be provided in a similar manner as the platform module 234, the institution data module 222 capability may be compatible with the monitoring preformed by the platform module 234. This may provide easy cross communications with the feed data on the institution data system 210 and the platform server 206.

Once feed data is received by the institution data module 222, the institution data module 222 may manage the feeds received by categorize and store the feed data. In some embodiments, the feed data may be categorized based on the type of feed received. The category feed data types are further illustrated below with respect to FIG. 3. The category feed data includes, but is not limited to search tools, social networking, wireless carrier data, financial institution data, market data, consumer transaction data, commercial transaction data, and entity and news information data. In this way, the institution data module 222 may receive the feed data and categorize it into one of the above mentioned categories. The feed data now categorized may be stored in the memory device 216 of the institution data system 210 as feed category data. The feed category data may also be provided to the platform server 206 via the communication device 212 of the institution data system 210 communicating with the communication device 224 of the platform server 206.

The institution data module 222 may then analyze the feed data to determine patterns for future trends based on the feed data received from the feed provider 202. The analysis may determine patterns to predict future trends in the financial, risk, and/or product development fields. For example, the patterns may include data regarding potential product development trends in toys. The patterns may be determined by data related to the toy development field, entities associated with toy development, secondary considerations, historic toy development and purchase data, and the like. In this way, the patterns may be able to predict toys that should be developed further in the future or toys that may lack public interest thus not a candidate for future development and marketing. Furthermore, the institution data module 222 may analyze the feed data to develop adjacent substitute trends based on inputs and outputs received and requested.

In some embodiments, pattern recognition may include recognizing the feed category data most requested by requestors and, in turn, determine the patterns therefrom. In this way, the institution data module 222 may be able to determine the feed category data that requestors frequently request based on communications with the platform server 206. In this way, the institution data module 222 may analyze the feed data that is most requested and determine subsequent patterns that may be offered to a requestor.

In some embodiments, the institution data module 222 provides for pattern learning. In communication with the platform module 234, the institution data module 222 may have an artificial intelligence aspect that allows the institution data module 222 to learn and predict patterns that may be used and or requested in the future by requestors. Using the platform module 234 monitoring capabilities the platform module 234 may determine the most requested data from the predictive analytics platform and communicate that to the institution data module 222. From this data, the institution data module 222 may then learn and predict the patterns that may be developed based on the most requested data. In this way, the institution data module 222 may learn, using artificial intelligence, potential patterns that may be requested by a requestor.

In some embodiments, the institution data module 222 may provide for pattern learning based on the feed category data that the institution data module 222 may receive from the feed provider 202 and the information based on the monitoring of the predictive analytics platform received from the monitoring functionality of the platform module 234.

In this way, the institution data system 210 may determine patterns that may predict future trends in the financial, risk, and/or product development fields based on the feed data received from a feed provider 202 and information regarding the access of feed data and patterns on the predictive analytics platform from the platform server 206. Therefore, the institution data system 210 may add patterns to the predictive analytics platform that the institution data system 210 may learn to be patterns that may be requested in the future by requestors accessing the predictive analytics platform. In this way, the institution data system 210 may learn of patterns for predicting future trends utilizing artificial intelligence and learning of potential future trends based on data received from feed providers 202 and information regarding the monitoring of the predictive analytics platform received from the platform module 234. In some embodiments, the functionality of both the institution data module 222 and the platform module 234 may occur in real-time.

As illustrated in FIG. 2 the feed provider system 204 is operatively coupled to the institution data system 210, the platform server 206, and/or the requestor systems 208 through the network 201. The feed provider system 204 have systems with devices the same or similar to the devices described for the institution data system 210 and the platform server 206 (i.e., a communication device, a processing device, and a memory device). Therefore, the feed provider system 204 communicates with the institution data system 210, the platform server 206, and/or the requestor system 208 in the same or similar way as previously described with respect to each system. The feed provider system 204, in some embodiments, is comprised of systems and devices that allow a feed provider 202 to provide feeds to and provide access to the predictive analytics platform. The feed provider system 204 may be, for example, a desktop personal computer, a mobile system such as a laptop, personal digital assistant (“PDA”), cellular phone, smart phone, or the like. Although only a single feed provider system 204 is depicted in FIG. 2, the predictive analytics system and environment 200 may contain numerous feed provider systems 204.

As further illustrated in FIG. 2, the requestor systems 208 are operatively coupled to the institution data system 210, the platform server 206, and/or the feed provider system 204 through the network 201. The requestor systems 208 have systems with devices the same or similar to the devices described for the feed provider system 204, the institution data system 210, and the platform server 206 (i.e., a communication device, a processing device, and a memory device). Therefore, the requestor systems 208 communicates with the institution data system 210, the platform server 206, and/or the feed provider system 204 in the same or similar way as previously described with respect to each system. The requestor systems 208, in some embodiments, are comprised of systems and devices that allow for requestors to access the predictive analytics platform and for the institution data system 210 and/or the platform server 206 to access the data of the requestor system 208.

FIG. 3 illustrates a predictive analytics feed process flow 300 including feed category data, in accordance with one embodiment of the present invention. The predictive analytics feeds 302 comprise several categories of feed category data. The feed categories include, but may not be limited to search tools 304, social networking 306, wireless carrier data 308, financial institution data 310, market data 312, consumer transactions 314, commercial transactions 316, and entity and news information 318.

Search tools 304, in some embodiments, include feeds such as search engine results, website searches, stock searchers, merchant searches, and/or other tools utilized for searching. In this way, feed providers 202 that possess data regarding individual or entity searches utilizing search tools 304 may provide the data to the predictive analytics platform. Social networking 306, in some embodiments, includes feeds from social networking sites, such as, but not limited to posts on blogs, comments, likes, posts, pictures, instant messages, etc. In this way, the feed provider 202 may allow access to his/her social networking or may operate a social networking media. Wireless carrier data 308, in some embodiments, includes feeds from wireless devices, such as, but not limited to text messages, voice messages, searches via a wireless device, mobile device data, GPS data, geo-spatial data, and other functions of a wireless device. In this way, the feed provider 202 may provide data from his/her wireless device or the feed provider may be a wireless carrier that may have access to wireless carrier information that may be provided as a predictive analytics feed.

Further illustrated in FIG. 3 is the predictive analytics feed 302 of financial institution data 310. Financial institution data 310, in some embodiments, includes feeds such as financial data, institution specific data, insurance data, or other data acquired by the institution. Financial data may include, but is not limited to account information, payment history, finances, debt, data uploaded from a social networking site, etc. Institution specific data may include, but is not limited to inventory data, profit data, sales data, margin data, social networking data, uploaded data, etc. Market data 312, in some embodiments, includes feeds regarding financial markets such as various stock markets, historical market trends. In this way, the feed provider 202 may be an individual investor or an entity associated with a stock or a stock market. The feed provider 202 may provide data from various stock markets, specific stocks, and other market data. Consumer transactions 314, in some embodiments, may include data from a feed provider 202 regarding a consumer purchase of a product or service, means of purchasing the product or service, information identifying the product or service being purchased, price the product was purchased for, point-of-transaction data, account data, etc. In this way, the feed provider 202 may be the individual involved in the transaction, the merchant providing the product or service, and/or a financial institution uniquely situated to be able to collect data regarding consumer transactions.

Further illustrated in FIG. 3 is the predictive analytics feed 302 of commercial transactions 316. Commercial transactions 316 include, but are not limited to commercial entities purchasing a product or service, means of purchasing the product or service, information identifying the product or service being purchased, price the product was purchased for, point-of-transaction data, orders, inventories, shipments, in-transit stock, company data, sales, annual reports, security camera data, etc. In this way, the feed provider 202 may be the commercial entity making the transaction, the merchant providing the product or service, and/or the financial institution financing the transaction. Entity and news information 318, in some embodiments, comprises news, press releases, conferences, mobile data, live television, traffic, etc. about either an entity or an event that the predictive analytics platform may dean to be relevant to predicting future trends in the fields of finance, risk, or product development.

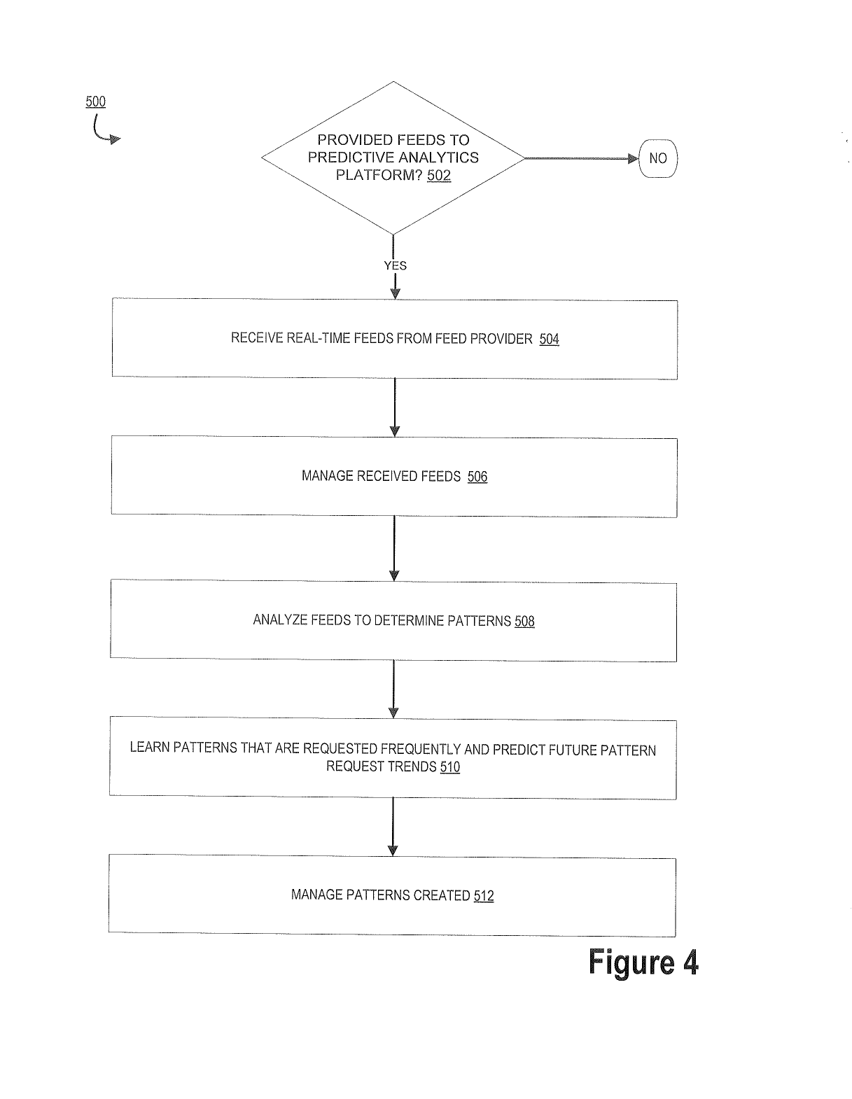

FIG. 4 illustrates a feed receiving process flow 500, in accordance with one embodiment of the present invention. The feed receiving process flow 500 illustrates how feeds are received from a feed provider 202 and subsequently put on the predictive analytics platform as feed category data and patterns. At decision block 502 the individual or entity may decide to provide feeds to the predictive analytics platform. If the individual or entity does not decide to provide feeds to the predictive analytics platform, the feed receiving process flow 500 may terminate for that particular individual or entity. If the individual or entity does decide to provide feeds to the predictive analytics platform in decision block 502, the individual or entity may then be a feed provider 202. In some embodiments, the individual or entity may communicate with the predictive analytics platform to that he/she wishes to provide feed data to the platform. In other embodiments, the predictive analytics platform may request from the individual or entity that he/she provides data to the platform. The feed data may be manually provided by the individual or entity or, in some embodiments the platform may automatically receive feed data.

Next, in block 504, the feed are received in real-time from the feed provider 202. As explained above, feeds may be received from feed providers 202, such as, but not limited to individuals, entities, such as manufacturers, merchants, website hosts, social network site hosts, search companies, manually inputted data, etc. The ability for vast quantities of data to be added to the predictive analytics platform in real-time may provide for several possible trend predictor patterns to be created. In this way, the predictive analytics platform may be able to receive data from numerous sources to provide an ever expanding platform from which predictive analytics may be performed. In this way, the feeds may be directed to the institution data system 210 at the same time the information is received at a third party. For example, if a feed provider 202 provides feeds from social networking sites, as soon as an individual or entity posts or blogs, that data may be provided to the predictive analytics platform upon the data being posted or updated. In this way, the predictive analytics platform may benefit from receiving feed data in real-time and thus having up to the minute data that may be analyzed for future trends in the financial, risk, or product development fields. Receipt of the feed data may be provided through an API, interface, automatically, manually, and/or the like based on the ease of use for a feed provider 202. An API may be provided in each of the systems or servers of the system or a central API may communicate with each of the systems or servers of the system. In this way, the software of each of the systems may be implemented to communicate a request to receive data from the predictive analytics platform.

As illustrated in block 506 of FIG. 4, the system may continually manage the feeds received in real-time from the feed providers 202. Management of the feeds may be performed by either the institution data system 210 or the platform server 206, as discussed in further detail above with respect to the institution data module 222 or the platform module 234 respectfully. Management of the feeds may include organizing the feeds received into feed categories such as, but not limited to search tools, social networking, wireless carrier data, financial institution data, market data, consumer transactions, commercial transactions, and/or entity and news information, as further discussed above with respect to FIG. 3. Managing the feeds receive may also comprise storing the feeds associated with the field that the particular feed may be associated with, such as the financial, risk, or product development field.

Furthermore, some feeds may need to be scrubbed, such that personal identifiable information may be hashed from the feed, so that the requestor may not be able to determine the individual or entity associated with a feed. Furthermore, managing feeds may further comprise monitoring the feed data on the platform and ensuring security of the feed data once it is one the platform. Monitoring the platform may include monitoring the data on the platform, monitoring use of the data, monitoring access to the data, monitoring requests for the data, etc. The data being monitored may include, but is not limited to the requests to provide feed data to the platform, the data being provided to the platform, the patterns on the platform, and the data or patterns that a requestor is viewing on the platform. In some embodiments, the feed providers 202 and the data the feed provider 202 may provide are monitored. This may provide the platform the ability to monitor the feed data that is coming in, to ensure no viruses, spyware, or misappropriation of that data is taking place as it is being provided to the platform in real-time. In some embodiments, the requestors that are accessing data and the requestors that are trying to access data are monitored. In yet other embodiments, the use of the data on the platform is monitored. Monitoring the use of the data on the platform may include, but is not limited to, monitoring who looks at the data, how long the requestor looks at the data, copying of the data, etc.

The management of received feeds, as illustrated in block 506 may further provide for security functionality. The security function may provide the predictive analytics platform with protection from security breaches, protection against data being exposed, limitation on the amount of data exposed, etc. The security functions include, but are not limited to, limiting data accessibility, determining data subsets available to requestors if necessary, and ensuring clean data on the platform. Data accessibility provides the platform with an ability to limit the accessibility of requestors based on the request. Allowing the requestor access to feed data subsets provides the security function the ability to manage the requestors who get the feed data and the amount the requestor is privy to, based on the determination of the host of the predictive analytics platform.

Next, as illustrated in block 508, once the feeds have been categorized, the feed category data may be analyzed to determine patterns in the data. In this way, the system may compile the feed data and determine patterns that may predict future trends in the financial, risk, or product development fields. For example, the patterns may include data regarding potential product development trends in video games. The patterns may be determined by data related to the product development field, entities associated with video game development, secondary considerations, historic video game development and purchase data, and the like. These trends may indicate that consumers are looking to purchase more and more first person combat games as opposed to sports related games. In this way, the patterns may be able to predict the games, such as first person combat games, that should be developed further in the future or games that may lack public interest thus not a candidate for future development and marketing.

Once the feeds have been analyzed to determine patterns in the data the system may learn patterns that are requested frequently and predict future pattern request trends, as illustrated in block 510. In some embodiments, pattern learning may include recognizing the feed category data most requested by requestors and, in turn, determine the patterns therefrom. In this way, the system may analyze the feed data that is most requested and determine subsequent patterns that may be offered to a requestor based on the most requested feed data.

In some embodiments, pattern learning may be provided by the system. The system, in some embodiments, may have an artificial intelligence aspect that allows the system to learn and predict patterns that may be used and or requested in the future by requestors. Using the system's monitoring capabilities as described above in FIG. 2, the most requested data from the predictive analytics platform may be determined. From this data, the system may then learn and predict the patterns that may be developed based on the most requested data. In this way, the system may learn, using artificial intelligence, potential patterns that may be requested by a requestor. In other embodiments, the system may learn patterns based on feed category data that is provided to the predictive analytics platform. In this way, the system may determine patterns that may predict future trends in the financial, risk, and/or product development fields based on the feed data received from a feed provider 202 and information regarding the access of feed data and patterns on the predictive analytics platform.

Once patterns are established by the system, the system may then, as illustrated in block 512 manage the created patterns. The management of patterns may occur in the same or similar manner as the management of the feeds. In this way, the patterns may also be stored in the system and easily searchable by any requestor with access. Furthermore, the patterns may be stored based on the field the pattern is associated with, such as, but not limited to financial, risk, and/or product development fields. The system may also create infographics and visualizations of the data and patterns associated therewith. In some embodiments, these infographics and visualizations may be provide to a requestor for an additional fee. The patterns may also be monitored similar to that way the feed are monitored, as described above. The monitoring of patterns may allow for subsequent patterns to be learned, as illustrated in block 510. Furthermore, monitoring the patterns on the predictive analytics platform also allows for security functionality of the patterns on the platform. In this way, only authorized requestors may have access some of the patterns available on the platform, and the security functionality ensures that the patterns are used for their intended purpose and viruses, etc. are not corrupting the patterns.

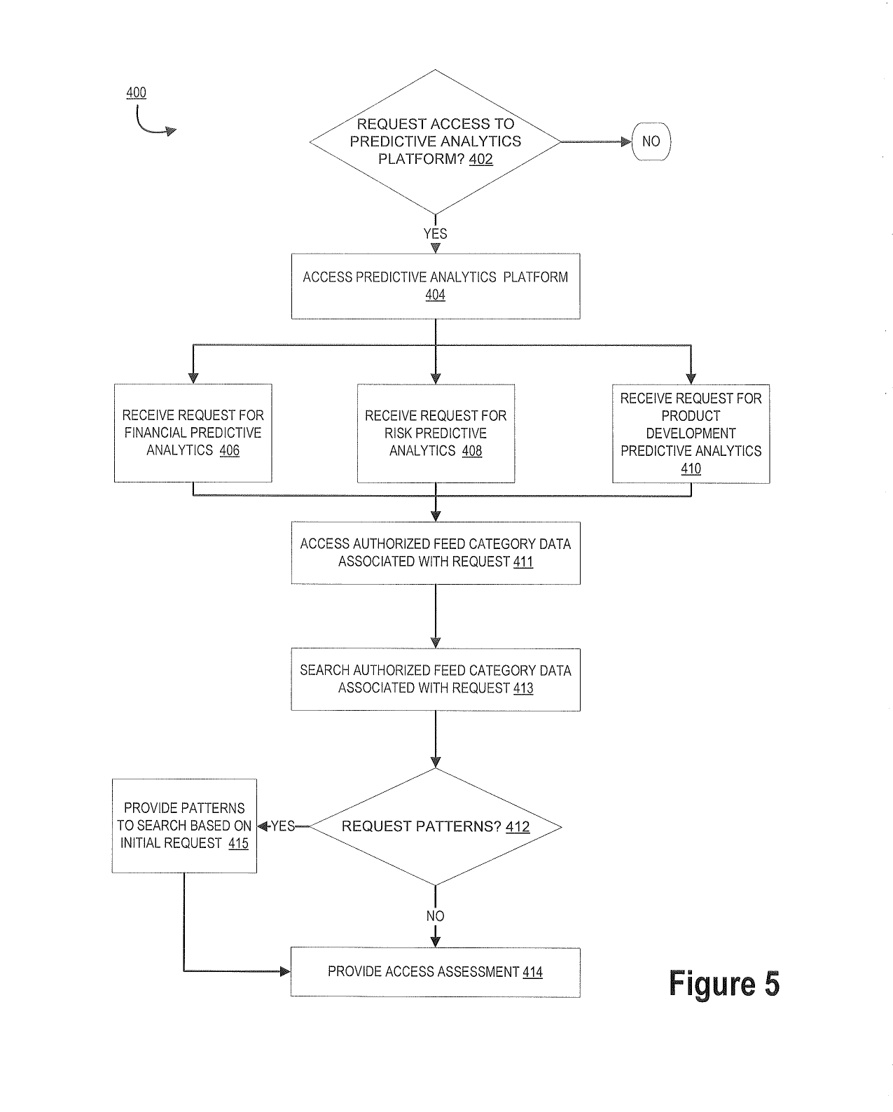

FIG. 5 illustrates a feed distribution process flow 400, in accordance with one embodiment of the present invention. As illustrated in decision block 402 an requestor may request access to the predictive analytics platform. If a requestor does not decide to request data or patterns at that time, the feed distribution process flow 400 is terminated. If the requestor does decide to request access to the predictive analytics platform in decision block 402 then the requestor may access the predictive analytics platform, as illustrated in block 404. The requestor may gain access to the predictive analytics platform if the requestor has been authorized by the system to do so. In this way, the platform may be protected from requestors who may not utilize the platform for its intended purposes, but instead potentially abuse the platform. Once the requestor has gained access to the predictive analytics platform in block 404, the requestor may request to receive financial predictive analytics in block 406, risk predictive analytics in block 408, and/or product development predictive analytics in block 410.

In some embodiments, as illustrated in block 406, the system may receive a request from a requestor for financial predictive analytics. Financial predictive analytics include any data associated with financial trends of individuals, entities, stocks, credits, purchasing, and/or other data that may be associated with financial trends of any aspect that there is feed data on the predictive analytics platform.

In some embodiments, as illustrated in block 408, the system may receive a request from a requestor for risk predictive analytics. Risk predictive analytics may include any data relating to trends in risk. In some embodiments, the trends in risk may include the risk associated with the purchasing a product and whether the risk trends tend to predict future increase or decrease with respect to an individual or entity purchasing that product. For example, future risk trends may determine that individuals or entities will be more likely to purchase property in the future than in the current purchasing climate. In other embodiments, trends in risk may include individual or entity risks, such as the risk associated with providing loans or credits to an individual or entity.

In some embodiments, as illustrated in block 410, the system may receive a request from a requestor for product or product development predictive analytics. Product development predictive analytics may include any data relating to products or services and the future trends relating to those products. Trends in product development may include predicting future popular products, services, product developments, etc. to aid an entity in determining products and services to market or provide more research and development funding for.

The predictive analytics data from financial, risk, and/or product development fields may also be cross utilized such that the data may be utilized together to predict various trends, patterns, etc. This cross utilization may include, but is not limited to prediction of small business markets developments, prediction of country/city/region market developments, validation o against other predictions made, baseline models, templates for use by requestors, and or the like.

Once the requestor has selected the predictive analytic data from financial, risk, or product development fields, the requestor may be allowed access to the authorized feed category data associated with the requestor's request, as illustrated in block 408. The data may be accessed on the platform by a requestor via a requestor's system 208 or any other means that a requestor may be able to access the platform. With access to the category data associated with the request, the requestor may search the authorized feed category data associated with the requestor's request, as illustrated in block 410. The requestor may be able to search via category, keyword, pattern, dropdown box, trend, field, and/or the like.

In some embodiments, after the requestor searches feed category data, as illustrated in block 410, the requestor may, in decision block 412 request patterns for future trends. If the requestor does request patterns, the requestor may be provided patterns to search, the patterns based on the initial request of the requestor, as illustrated in block 410. In this way, if the requestor originally requests financial predictive analytics in block 406, the requestor may be limited to searching only patterns associated with financial predictive analytics.

Once the requestor has search patterns or if the requestor did not request patterns, the system may provide access fees to the requestor in block 414. In this way, fees that a requestor may owe, if any, may be determined based on the requestor accessing the platform, the amount of data the requestor accessed, etc. In this way, fees may be based on the number of times a requestor accesses the platform, the amount of data requested from the platform, a flat fee, a subscription fee, and/or a royalty based on use of the data on the platform. In some embodiments, a fee may be charged to a requestor depending on the number of times the requestors accessed the platform. For example, a requestor may only wish to access the platform one time, in this case the fee would be charged for that one access. If a requestor wished to access the platform a number of times, each time the requestor accessed the platform a fee would be charged. In other embodiments, a fee may be charged based on the amount of data the requestor requests from the platform. This fee may also be dependent on the type of data requested. In yet another example fees may be determined by using subscription fees for use of the predictive analytics platform. In this way, a requestor may provide a weekly/monthly/annually fee for use of the predictive analytics platform at any time.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, etc.), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein. As used herein, a processor may be “configured to” perform a certain function in a verity of ways, including, for example, by having one or more general-purpose circuits perform the functions by executing one or more computer-executable program code portions embodied in a computer-readable medium, and/or having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out operations of the present invention may include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, etc.) that can direct a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

1. A method for providing a predictive analytics platform, the method comprising:
receiving data feeds from feed providers, wherein the feed providers are merchants or customers of the merchant;
storing in a storage device data feeds provided by feed providers, wherein the data feeds are received in real-time, wherein the storage of the data feeds provided by the feed providers includes storage in a searchable format;
managing the data feeds by storing the data feeds based at least in part on a field associated with each data feed, wherein a data feed is stored in association with one or more fields, wherein the fields include financial or product development fields;
predicting patterns, via a computer device processor, from the data feeds using predictive analytics and store the patterns determined for the field with the data feeds, wherein the patterns indicate future trends in the fields;
receiving one or more requests from one or more requestors to access either one or both an individual data feed from the received data feeds or one or more of the patterns determined for the field;
determining which individual data feeds and patterns are requested most frequently;
analyzing the data feeds and patterns that are requested most frequently by the one or more requestors and the type of requestor requesting access either one or both the individual data feed or the one or more patterns; and
determining, based at least in part on analyzing the data feeds requested most frequently, the patterns requested most frequently, and the one or more requestors requesting the predicted patterns or the individual data feed, subsequent patterns, wherein the subsequent patterns are determined by analyzing the data feeds and patterns requested most frequently with the requestors, wherein the subsequent patterns indicate future trends for the fields.

2. The method of claim 1 further comprising receiving an assessment from a requestor for the use of the predictive analytics platform, wherein the assessment is based at least in part on the feed data or patterns the requestor accesses.

3. The method of claim 1, wherein the patterns indicate future trends in one or more of financial, risk, or product development fields.

4. The method of claim 1, wherein the feeds provided by the feed provider relate to one or more of financial, risk, or product development fields.

5. The method of claim 1 further comprising receiving feed data from the feed provider automatically, wherein the feed data is received in real-time upon the submission of feed data to a third party.

6. The method of claim 5, wherein the third party hosts a mobile device, wherein upon submission of data to the mobile device, the data is received in real-time as feed data at the predictive analytics platform.

7. The method of claim 5, wherein the third party hosts a website, wherein upon submission of data to a website, the data is received in real-time as feed data at the predictive analytics platform.

8. The method of claim 5, wherein the third party is a financial institution, wherein upon submission of data during a transaction, the data is received in real-time as feed data at the predictive analytics platform.

9. The method of claim 1 further comprising determining a compensation amount to provide to the feed provider based at least in part on the amount of data provided by the feed provider.

10. The method of claim 1 further comprising adjusting the category associated with each data feed to include more categories relating to more frequently requested data feeds.

11. A system for providing a predictive analytics platform, the system comprising:
a memory device;
a communication device; and
a processing device operatively coupled to the memory device and the communication device, wherein the processing device is configured to execute computer-readable program code to:
receive data feeds from feed providers, wherein the feed providers are merchants or customers of the merchant;
store in a storage device data feeds provided by feed providers, wherein the data feeds are received in real-time, wherein the storage of the data feeds provided by the feed providers includes storage in a searchable format;
manage the data feeds by storing the data feeds based at least in part on a field associated with each data feed, wherein a data feed is stored in association with one or more fields, wherein the fields include financial or product development fields;
predict patterns from the data feeds using predictive analytics and store the patterns determined for the field with the data feeds, wherein the patterns indicate future trends in the fields;
receive one or more requests from one or more requestors to access either one or both an individual data feed from the received data feeds or one or more of the patterns determined for the field;
determine which individual data feeds and patterns are requested most frequently;
analyze the data feeds and patterns that are requested most frequently by the one or more requestors and the type of requestor requesting access either one or both the individual data feed or the one or more patterns; and
determine, based at least in part on analyzing the data feeds requested most frequently, the patterns requested most frequently, and the one or more requestors requesting the predicted patterns or the individual data feed, subsequent patterns, wherein the subsequent patterns are determined by analyzing the data feeds and patterns requested most frequently with the requestors, wherein the subsequent patterns indicate future trends for the fields.

12. The system of claim 11, wherein the processing device is further configured to receive an assessment from a requestor for the use of the predictive analytics platform, wherein the assessment is based at least in part on the feed data and/or patterns the requestor accesses.

13. The system of claim 11, wherein the patterns indicate future trends in one or more of financial, risk, or product development fields.

14. The system of claim 11, wherein the feeds provided by the feed provider relate to one or more of financial, risk, or product development fields.

15. The system of claim 11, wherein the processing device is further configured to receive feed data from the feed provider automatically, wherein the feed data is received in real-time upon the submission of feed data to a third party.

16. The system of claim 15, wherein the third party hosts a mobile device, wherein upon submission of data to the mobile device, the data is received in real-time as feed data at the predictive analytics platform.

17. The system of claim 15, wherein the third party hosts a website, wherein upon submission of data to a website, the data is received in real-time as feed data at the predictive analytics platform.

18. The system of claim 15, wherein the third party is a financial institution, wherein upon submission of data during a transaction, the data is received in real-time as feed data at the predictive analytics platform.

19. The system of claim 11, wherein the processing device is further configured to determine a compensation amount to provide to the feed provider based at least in part on the amount of data provided by the feed provider.

20. The system of claim 11, wherein the processing device is further configured to adjust the category associated with each data feed to include more categories relating to more frequently requested data feeds.

21. A computer program product for providing a predictive analytics platform, the computer program product comprising at least one non-transitory computer-readable medium having computer-readable program code portions embodied therein, the computer-readable program code portions comprising:
an executable portion configured for receiving data feeds from feed providers, wherein the feed providers are merchants or customers of the merchant;
an executable portion configured for storing in a storage device data feeds provided by feed providers, wherein the data feeds are received in real-time, wherein the storage of the data feeds provided by the feed providers includes storage in a searchable format;
an executable portion configured for managing the data feeds by storing the data feeds based at least in part on a field associated with each data feed, wherein a data feed is stored in association with one or more fields, wherein the fields include financial or product development fields;
an executable portion configured for predicting patterns from the data feeds using predictive analytics and store the patterns determined for the field with the data feeds, wherein the patterns indicate future trends in the fields;
an executable portion configured for receiving one or more requests from one or more requestors to access either one or both an individual data feed from the received data feeds or one or more of the patterns determined for the field;
an executable portion configured for determining which individual data feeds and patterns are requested most frequently;
an executable portion configured for analyzing the data feeds and patterns that are requested most frequently by the one or more requestors and the type of requestor requesting access either one or both the individual data feed or the one or more patterns; and
an executable portion configured for determining, based at least in part on analyzing the data feeds requested most frequently, the patterns requested most frequently, and the one or more requestors requesting the predicted patterns or the individual data feed, subsequent patterns, wherein the subsequent patterns are determined by analyzing the data feeds and patterns requested most frequently with the requestors, wherein the subsequent patterns indicate future trends for the fields.

22. The computer program product of claim 21 further comprising an executable portion configured for receiving an assessment from a requestor for the use of the predictive analytics platform, wherein the assessment is based at least in part on the feed data and/or patterns the requestor accesses.

23. The computer program product of claim 21, wherein the patterns indicate future trends in one or more of financial, risk, or product development fields.

24. The computer program product of claim 21, wherein the feeds provided by the feed provider relate to one or more of financial, risk, or product development fields.

25. The computer program product of claim 21 further comprising an executable portion configured for receiving feed data from the feed provider automatically, wherein the feed data is received in real-time upon the submission of feed data to a third party.

26. The computer program product of claim 25, wherein the third party hosts a mobile device, wherein upon submission of data to the mobile device, the data is received in real-time as feed data at the predictive analytics platform.

27. The computer program product of claim 25, wherein the third party hosts a website, wherein upon submission of data to a website, the data is received in real-time as feed data at the predictive analytics platform.

28. The computer program product of claim 25, wherein the third party is a financial institution, wherein upon submission of data during a transaction, the data is received in real-time as feed data at the predictive analytics platform.

29. The computer program product of claim 21 further comprising an executable portion configured for determining a compensation amount to provide to the feed provider based at least in part on the amount of data provided by the feed provider.

30. The computer program product of claim 21 further comprising an executable portion configured for adjusting the category associated with each data feed to include more categories relating to more frequently requested data feeds.
